(19) United States
(12) Patent Application Publication
(10) Pub. No.: US 2015/0096297 A1
(43) Pub. Date: Apr. 9, 2015

(54) Exhaust Heat Recovery Device

(71) Applicant: SANDEN CORPORATION, Isesaki-shi, Gunma (JP)

(72) Inventors: Tomonori Haraguchi, Isesaki-shi (JP); Hirofumi Wada, Isesaki-shi (JP)

(21) Appl. No.: 14/400,286

(22) PCT Filed: May 2, 2013
(86) PCT No.: PCT/JP2013/062788

§ 371 Date: Nov. 10, 2014

(30) Foreign Application Priority Data
May 9, 2012 (JP) 2012-107316

(51) Int. Cl. F01K 23/10; F02G 5/02; F01D 19/00; F01D 17/08

(52) U.S. Cl. CPC F01K 23/101; F01D 17/08; F02G 5/02; F01D 19/00
USPC 60/615; 60/618

(57) ABSTRACT

An exhaust heat recovery device provided with a Rankine cycle, capable of achieving improvements in start-up performance of the Rankine cycle and an efficient operation (actuation) of the Rankine cycle. An exhaust heat recovery device 1 that recovers and uses exhaust heat of an engine 10 includes: a Rankine cycle 2 including a heater 22, an expander 23, a condenser 24, and a pump 25; a bypass flow passage 26 that allows refrigerant to circulate while bypassing the expander 23; a bypass valve 27 that opens and closes the bypass flow passage 26; and a control unit 4. When starting up the Rankine cycle 2, the control unit 4 executes control to actuate the pump 25 with the bypass valve 27 open, and then to close the bypass valve 27 when a parameter indicating the condensation capacity of the condenser 24 becomes a predetermined value or more.

### TECHNICAL FIELD

The present invention relates to an exhaust heat recovery device provided with a Rankine cycle that recovers exhaust heat of an external heat source such as an engine and regenerates the exhaust heat as power.

### BACKGROUND ART

As this type of device, for example, a waste-heat reusing device disclosed in Patent Document 1 has been known. The waste-heat reusing device disclosed in Patent Document 1 has: a Rankine cycle which is equipped with a pump, a heater, an expander, and a condenser; a bypass flow passage which bypasses the expander; and a bypass valve that opens and closes the bypass flow passage. Moreover, when starting up the Rankine cycle, refrigerant is first circulated with the bypass valve open, and when a temperature of gaseous-phase refrigerant on an inlet side of the expander becomes a predetermined temperature or higher, the bypass valve is closed, and operating rotational speed of the expander is made to increase.

In the waste-heat reusing device disclosed in Patent Document 1, it is possible to perform stable start-up of the Rankine cycle by reducing an occurrence of sudden pressure difference in the expander.

### REFERENCE DOCUMENT LIST

### Patent Document

Patent Document 1: Japanese Patent Application Laid-open Publication No. 2009-97387

### SUMMARY OF THE INVENTION

### Problems to be Solved by the Invention

A pump that circulates the refrigerant in the Rankine cycle is a liquid feeding pump, and it is assumed that the refrigerant on the inlet side of the pump be in a liquid-phase state (liquid refrigerant). However, when the pump is installed at a position higher than a refrigerant liquid level in a receiver tank, for example, due to a limitation on a layout, the refrigerant on the inlet side of the pump may become a gaseous-phase state (gaseous refrigerant) during stop of the Rankine cycle. If the pump is actuated in a state in which the gaseous refrigerant is mixed on the inlet side of the pump in this manner, a sufficient amount of circulating refrigerant cannot be obtained, and accordingly, it takes a long time to start up the Rankine cycle, or there might be a risk of failure in start-up of the Rankine cycle. That is, the start-up performance of the Rankine cycle (such as rapidity of start-up and reliability of start-up) decreases. For this reason, when starting up the Rankine cycle, it is necessary that the refrigerant on the inlet side of the pump be liquid refrigerant as much as possible.

Through experiments of the inventors, it has been confirmed that in a condition in which the gaseous refrigerant is mixed on the inlet side of the pump, when the refrigerant is circulated while bypassing the expander, it is possible to convert the refrigerant on the inlet side of the pump into the liquid refrigerant in a shorter time than in a case in which the refrigerant is circulated via the expander. Therefore, when starting up the Rankine cycle, it is preferred to circulate the refrigerant while bypassing the expander. Meanwhile, while circulating the refrigerant by bypassing the expander, the output from the expander cannot be obtained, and thus, the output of the Rankine cycle becomes negative due to the driving load or the like of the pump. It is therefore desirable to shorten the time for circulating the refrigerant while bypassing the expander as much as possible.

In the above-described conventional waste-heat reusing device, it has not been considered at all about shortening the time for circulating the refrigerant while bypassing the expander, in other words, about shortening an operating time (operation time) of the Rankine cycle at which the output becomes a negative state, as much as possible. Therefore, when starting up the Rankine cycle, the conventional waste-heat reusing device may be possible to prevent an occurrence of rapid pressure difference in the expander, but the time in which the output of the Rankine cycle is negative becomes longer than necessary, and the Rankine cycle may be operated inefficiently.

The present invention has been made in view of such points, and an object thereof is to provide an exhaust heat recovery device provided with a Rankine cycle, capable of achieving both improvements in start-up performance of the Rankine cycle and an efficient operation (actuation) of the Rankine cycle.

### Means for Solving the Problems

An exhaust heat recovery device according to an aspect of the present invention includes: a Rankine cycle in which a heater configured to heat and vaporize refrigerant by exhaust heat of an external heat source, an expander configured to generate power by expanding the refrigerant passed through the heater, a condenser configured to condense the refrigerant passed through the expander, and a pump configured to send the refrigerant passed through the condenser to the heater are disposed in a circulation passage of the refrigerant; a bypass flow passage that allows the refrigerant to circulate while bypassing the expander; a bypass valve that opens and closes the bypass flow passage; and a control unit that, when starting up the Rankine cycle, executes control to actuate the pump with the bypass valve open, and then to close the bypass valve when a parameter indicating condensation capacity of the condenser becomes a predetermined value or more.

### Effects of the Invention

According to the exhaust heat recovery device, when starting up the Rankine cycle, the pump is actuated with the bypass valve open, and thus, even when the gaseous refrigerant is mixed on the inlet side of the pump, it is possible to shorten the time until the refrigerant on the inlet side of the pump becomes the liquid refrigerant. Furthermore, since the bypass valve is closed when the parameter indicating the condensation capacity of the condenser becomes a predetermined value or more, the refrigerant can be circulated via the expander immediately after being in a state in which the refrigerant on the inlet side of the pump is sufficiently liquefied. As a result, the start-up performance of the Rankine cycle can be improved, and the efficient operation (actuation) of the Rankine cycle can be performed by reducing the time in which the output of the Rankine cycle becomes negative.

### BRIEF DESCRIPTION OF THE DRAWINGS

FIG. 1 is a diagram illustrating a schematic configuration of an exhaust heat recovery device according to an embodiment of the present invention.

FIG. 2 is a flowchart illustrating Rankine start-up control in the embodiment.

FIG. 3 is a flowchart illustrating the Rankine start-up control in the embodiment.

FIG. 4 is a timing diagram of the Rankine start-up control.

FIG. 5 is a diagram illustrating a schematic configuration of an exhaust heat recovery device according to a modified example of the embodiment.

### MODE FOR CARRYING OUT THE INVENTION

Hereinafter, an embodiment of the present invention will be described with reference to the accompanying drawings.

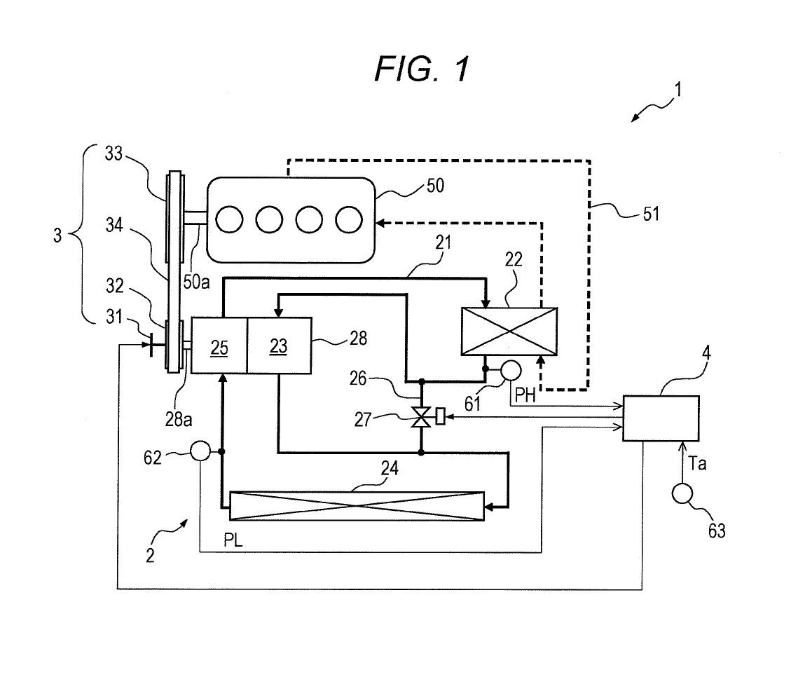

FIG. 1 illustrates a schematic configuration of an exhaust heat recovery device 1 according to an embodiment of the present invention. The exhaust heat recovery device 1 is mounted on a vehicle, and recovers and uses exhaust heat of an engine 50 of the vehicle. As illustrated in FIG. 1, the exhaust heat recovery device 1 includes: a Rankine cycle 2 that recovers the exhaust heat of the engine 50 and converts the exhaust heat into power; a transmission mechanism 3 that performs power transmission between the Rankine cycle 2 and the engine 50; and a control unit 4 that controls the overall operation of the exhaust heat recovery device 1.

The engine 50 is a water-cooled internal combustion engine and is cooled by engine cooling water that circulates in a cooling water flow passage 51. A heater 22 of the Rankine cycle 2 to be described later is arranged on the cooling water flow passage 51, so that the engine cooling water that has absorbed heat from the engine 50 flows through the heater 22.

The Rankine cycle 2 recovers the exhaust heat (heat of the engine cooling water in this case) of the engine 50 as an external heat source, converts it into power, and outputs the power. In a refrigerant circulation passage 21 of the Rankine cycle 2, there are arranged the heater 22, an expander 23, a condenser 24, and a pump 25, in this order. Furthermore, between the heater 22 and the condenser 24, a bypass passage 26 through which refrigerant flows to bypass the expander 23 is provided, and a bypass valve 27 that opens and closes the bypass passage 26 is provided in the bypass passage 26. Operation of the bypass valve 27 is controlled by the control unit 4.

The heater 22 is a heat exchanger which heats the refrigerant to obtain superheated vapor, by performing heat exchange between the engine cooling water that has absorbed heat from the engine 50 and the refrigerant. Alternatively, the heater 22 may be configured to perform heat exchange between the refrigerant and the exhaust gas of the engine 10, instead of the engine cooling water.

The expander 23 is, for example, a scroll type expander that generates power (driving force) by expanding the refrigerant, which is the superheated vapor heated by the heater 22, and by converting it into the rotational energy.

The condenser 24 is a heat exchanger which cools and condenses (liquefies) the refrigerant, by performing heat exchange between the refrigerant passed through the expander 23 and the ambient air.

The pump 25 is a mechanical pump that sends the refrigerant (liquid refrigerant) liquefied by the condenser 24 to the heater 22. Thus, since the refrigerant, which has been liquefied by the condenser 24, is sent to the heater 22 by the pump 25, the refrigerant circulates through each of the elements of the Rankine cycle 2.

Here, in this embodiment, the expander 23 and the pump 25 are integrally connected and configured as a “pump-integrated expander 28” having a common rotating shaft 28a. That is, the rotating shaft 28a of the pump-integrated expander 28 has a function as an output shaft of the expander 23 and a function as a drive shaft of the pump 25.

The transmission mechanism 3 has a pulley 32 that is attached to the rotating shaft 28a of the pump-integrated expander 28 via an electromagnetic clutch 31, a crank pulley 33 that is attached to a crankshaft 50a of the engine 50, and a belt 34 that is wrapped around the pulley 32 and the crank pulley 33. The electromagnetic clutch 31 is controlled to be turned on (engaged) and turned off (disengaged) by the control unit 4, so that the transmission mechanism 3 transfers and cuts off power between the engine 50 and the Rankine cycle 2 (more specifically, the pump-integrated expander 28).

Measurement signals of various sensors, such as a first pressure sensor 61 configured to measure a high-pressure side pressure PH of the Rankine cycle 2, a second pressure sensor 62 configured to measure a low-pressure side pressure PL of the Rankine cycle 2, and a temperature sensor 63 configured to measure a temperature Ta of ambient air, are input to the control unit 4. When starting up the Rankine cycle 2, the control unit 4 executes Rankine start-up control to be described later.

The high-pressure side pressure PH of the Rankine cycle 2 refers to a pressure in the refrigerant circulation passage 21 in a section extending from (the outlet of) the pump 25 to (the inlet of) the expander 23 through the heater 22, and the low-pressure side pressure PL of the Rankine cycle 2 refers to a pressure in the refrigerant circulation passage 21 in a section extending from (the outlet of) the expander 23 to (the inlet of) the pump 25 through the condenser 24. In this embodiment, the first pressure sensor 61 measures the pressure on the inlet side of the expander 23 (the outlet side of the heater 22) as the high-pressure side pressure PH of the Rankine cycle 2, and the second pressure sensor 62 measures the pressure on the inlet side of the pump 25 (the outlet side of the condenser 24) as the low-pressure side pressure PL of the Rankine cycle 2.

Next, the Rankine start-up control executed by the control unit 4 will be described.

As described above, in a state in which the gaseous refrigerant is mixed into the refrigerant on the inlet side of the pump 25, it has been confirmed that it is possible to shorten the time until the refrigerant on the inlet side of the pump 25 becomes approximately 100% of liquid refrigerant, by actuating the pump 25 with the bypass valve 27 open, that is, by circulating the refrigerant while bypassing the expander 23. This may be believed to be due to the following reasons. That is, if the refrigerant circulates via the expander 23, expansion of the refrigerant occurs in the expander 23, and thus, the low-pressure side pressure PL decreases and the condensation temperature decreases. For this reason, in the condenser 24, the temperature difference between the condensation temperature and the temperature of the passing air is reduced, resulting in an operation state in which the degree of supercooling (subcooling) of the refrigerant is hard to increase.

Furthermore, the inventors have confirmed that, in a case in which the refrigerant is circulated with the bypass valve 27 open, and the bypass valve 27 is closed after the refrigerant on the inlet side of the pump 25 is sufficiently liquefied, more specifically, after the refrigerant on the inlet side of the pump 25 becomes approximately 100% of liquid refrigerant, the reliability of the start-up of the Rankine cycle 2 can be improved.

Therefore, at the time of starting up the Rankine cycle 2, by actuating the pump 25 with the bypass valve 27 open at first, and then, by closing the bypass valve 27 after the refrigerant on the inlet side of the pump 25 is sufficiently liquefied, in other words, after a parameter indicating the condensation capacity of the condenser 24 becomes a predetermined value or more, the start-up performance (rapidity and reliability of start-up) of the Rankine cycle 2 can be improved and the Rankine cycle 2 can be efficiently operated with the operating time, in which output of the Rankine cycle 2 is negative, reduced to a minimum required time. Therefore, the control unit 4 executes the Rankine start-up control of the above-described contents.

Here, in this embodiment, a pressure difference ΔP between the high-pressure side pressure PH and the low-pressure side pressure PL of the Rankine cycle 2 is used as a parameter indicating the condensation capacity of the condenser 24. The reasons are as follows.

As a ratio of the liquid refrigerant on the inlet side of the pump 25 increases, the refrigerant flow rate increases, and the condensation capacity in the condenser 22 also increases (condensation capacity=refrigerant enthalpy difference before and after condenser×refrigerant flow rate). Thus, the refrigerant flow rate is a value indicating magnitude of the condensation capacity. Moreover, the refrigerant flow rate is correlated with the pressure loss of the refrigerant circuit (as the refrigerant flow rate increases, the pressure loss of the refrigerant circuit also increases). When the bypass valve 27 is open, the pressure difference between the high-pressure side and the low-pressure side is equal to the pressure loss of the refrigerant circuit, and accordingly, the pressure difference is a value having a correlation with the refrigerant flow rate. Therefore, by determining the pressure difference ΔP, it is possible to easily determine (detect) the condensation capacity of the condenser 24, more specifically, whether the refrigerant on the inlet side of the pump 25 becomes substantially 100% of liquid refrigerant, and the use of the pressure difference ΔP, which has less hunting or the like, can achieve a stable control.

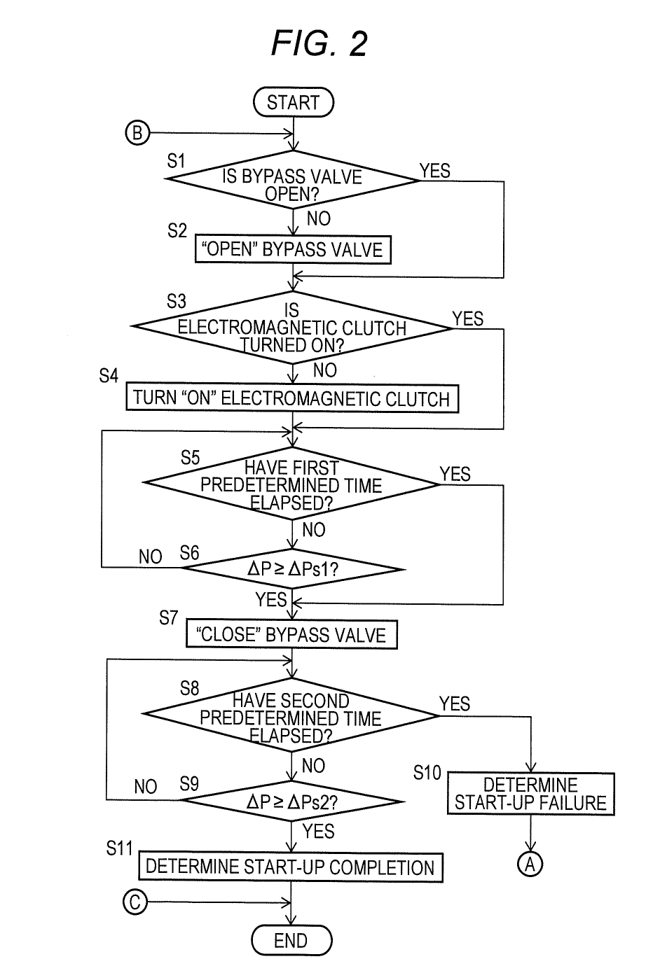

FIGS. 2 and 3 are flowcharts of the Rankine start-up control.

The control in these flowcharts is initiated, for example, upon receiving the operation request or the operation permission of the Rankine cycle 2.

At step S1, it is determined whether the bypass valve 27 is open. If the bypass valve 27 is closed, the process proceeds to step S2, and if the bypass valve 27 is open, the process proceeds to step S3.

At step S2, the bypass valve 27 is opened.

In this embodiment, during stop of the Rankine cycle 2, the bypass valve 27 is open typically. For this reason, in the first Rankine start-up control, the process of the above-described step S2 may be typically omitted. Meanwhile, since the bypass valve 27 is closed in the redone Rankine start-up control (S10→S12→S1) after a start-up failure (see step S10 which will be described later), the bypass valve 27 is opened at the above-described step S2.

At step S3, it is determined whether the electromagnetic clutch 31 is turned on (engaged). When the electromagnetic clutch 31 is not turned on, that is, when it is the first time the Rankine start-up control is executed, the process proceeds to step S4, and when the electromagnetic clutch 31 is already turned on, that is, when the Rankine start-up control is redone, the process proceeds to step S5.

At step S4, the electromagnetic clutch 31 is turned on (engaged). When the electromagnetic clutch 31 is turned on, the rotating shaft 28a is driven to rotate by the engine 50, and the pump 25 is actuated.

By the above-described steps S1 to S4, the refrigerant circulates while bypassing the expander 23.

At step S5, it is determined whether a first predetermined time has elapsed from the beginning of the circulation of the refrigerant with the expander 23 bypassed. That is, in the first time the Rankine start-up control is executed, it is determined whether the first predetermined time has elapsed after turning on the electromagnetic clutch 31 at step S4, and in redoing of the Rankine start-up control, it is determined whether the first predetermined time has elapsed after opening the bypass valve 27 at step S2. When the first predetermined time has not elapsed, the process proceeds to step S6. Meanwhile, when the first predetermined time has elapsed, the process proceeds to step S7. The first predetermined time is set in advance to a period of time enough to sufficiently liquefy the refrigerant on the inlet side of the pump 25 (enough to be substantially 100% of liquid refrigerant) by actuating the pump 25 with the bypass valve 27 open, and the first predetermined time may be, for example, 120 seconds.

At step S6, it is determined whether the pressure difference ΔP between the high-pressure side pressure PH and the low-pressure side pressure PL of the Rankine cycle 2 is equal to or greater than a first predetermined value ΔPs1. When the pressure difference ΔP is less than the predetermined value ΔPs1, the process returns to step S5, and when the pressure difference ΔP is equal to or greater than the predetermined value ΔPs1, the process proceeds to step S7. The first predetermined value ΔPs1 is a value that is set in advance to a pressure difference between the high-pressure side and the low-pressure side of the Rankine cycle 2 when a sufficient amount of liquid refrigerant (approximately 100%) is supplied to the pump 25 on the inlet side thereof, and the first predetermined value ΔPs1 is a determination reference value of whether to close the bypass valve 27. The first predetermined value ΔPs1 may be, for example, any value between 0.1 to 0.25 MPa.

At step S7, the bypass valve 27 is closed. Thus, the refrigerant circulates via the expander 23.

By the above-described steps S5 to S7, the time of circulating the refrigerant while bypassing the expander 23 can be prevented from becoming longer than necessary, and it is possible to circulate the refrigerant via the expander 23 immediately after the refrigerant on the inlet side of the pump 25 becomes a sufficiently liquefied state.

The first predetermined value ΔPs1 (determination reference value) used at the above-described step S6 may be set based on the temperature Ta of ambient air. In this case, the control unit 4 sets the first predetermined value ΔPs1 to a greater value as the temperature Ta of ambient air decreases.

As the temperature Ta of ambient air decreases, the radiation performance of the condenser 24 increases, and the condensation temperature and the refrigerant temperature at the inlet of the pump 25 decrease. As a result, the refrigerant temperature at the inlet of the heater 22 on the high-pressure side also decreases, and the amount of liquid-phase refrigerant increases inside the heater 22. Therefore, the amount of refrigerant on the low-pressure side decreases, and the degree of supercooling at the inlet of the pump 25 also decreases. Thus, on condition that the ambient air is low, an operation state becomes a state in which the degree of supercooling at the inlet of the pump 25 is hard to increase. That is, the inlet of the pump 25 becomes a condition in which the refrigerant is hard to be liquefied. Therefore, in a case in which the temperature Ta of ambient air is low, when it is determined whether to close the bypass valve 27 using the same determination reference value, there is a possibility that the refrigerant at the inlet of the pump 25 is not sufficiently liquefied and a condition unfavorable to the start-up may occur.

Therefore, the control unit 4 sets the first predetermined value ΔPs1 to a greater value as the temperature Ta of ambient air decreases. This causes the timing of closing the bypass valve 27 to be substantially delayed, and the inlet of the pump 25 becomes a condition in which the refrigerant is easily liquefied, and thus, it is possible to improve the reliability of the start-up. For example, the first predetermined value ΔPs1 may be about 0.15 MPa when the temperature Ta of ambient air is 25° C., and the first predetermined value ΔPs1 may be about 0.2 MPa when the temperature Ta of ambient air is 5° C.

Similar to the case in which the temperature Ta of ambient air is low, when the flow rate of ambient air passing through (outside of) the condenser 24 increases, the heat radiation performance of the condenser 24 also becomes higher. Therefore, the control unit 4 may be input with a vehicle speed, for example, from an engine control unit (not illustrated) and may set the first predetermined value ΔPs1 based on the input vehicle speed. In this case, the first predetermined value ΔPs1 is set to a greater value as the vehicle speed increases. It should be apparent that the control unit 4 may set the first predetermined value ΔPs1 based on both the temperature Ta of ambient air and the vehicle speed.

Returning to FIG. 2, at step S8, it is determined whether a second predetermined time (<the first predetermined time) has elapsed after closing the bypass valve 27. When the second predetermined time has not elapsed, the process proceeds to step S9. Meanwhile, when the second predetermined time has elapsed, the process proceeds to step S10 and the “start-up failure” is determined, and then, the process proceeds to step S12. The second predetermined time is set in advance to a period of time in which the pressure difference ΔP can reach a second predetermined value ΔPs2 in the normal operation (actuation) of the Rankine cycle 2, and may be, for example, 30 seconds.

At step S9, it is determined whether the pressure difference ΔP between the high-pressure side pressure PH and the low-pressure side pressure PL of the Rankine cycle 2 is equal to or greater than the second predetermined value ΔPs2 (>first predetermined value ΔPs1). When the pressure difference ΔP is equal to or greater than the second predetermined value ΔPs2, the process proceeds to step S11, to determine “start-up completion” and terminate the flow (Rankine start-up control). Meanwhile, at step S9, when the pressure difference ΔP is less than the second predetermined value ΔPs2, the process returns to step S8. The second predetermined value ΔPs2 is a start-up determination threshold value of the Rankine cycle 2, and may be, for example, 0.8 MPa.

By the above-described steps S8 to S11, it is determined whether the pressure difference ΔP reaches the second predetermined value ΔPs2, which is the start-up determination threshold value, within the second predetermined time after closing the bypass valve 27. Then, when the pressure difference ΔP reaches the second predetermined value ΔPs2, “start-up completion” is determined, and when the pressure difference ΔP does not reach the second predetermined value ΔPs2, the “start-up failure” is determined.

When the start-up of the Rankine cycle 2 is completed, the expander 23 is adapted to drive the pump 25 by generating the driving force, and when the driving force of the expander 23 exceeds the drive load of the pump 25, the surplus driving force is supplied to the engine 50 via the transmission mechanism 3 to assist the engine output.

At step S12 (FIG. 3), it is determined whether the “start-up failure” determination continues for a predetermined number of times (for example, three times). When the “start-up failure” determination continues for the predetermined number of times, the process proceeds to step S13, and “start-up impossibility” is determined, and thereafter, the bypass valve 27 is opened at step S14, and the electromagnetic clutch 31 is turned off (disengaged) at step S15, to terminate the flow (Rankine start-up control). In this case, the actuation (operation) of the Rankine cycle 2 is not performed. Here, when the “start-up impossibility” is determined, since it is assumed that there are some kinds of abnormality in the Rankine cycle 2, such as a shortage of the amount of refrigerant, it is preferable to notify the occupant or the like of the vehicle that there is abnormality in the Rankine cycle 2 by a warning light, a display, or the like.

Meanwhile, when the number of the “start-up failure” determinations is less than the predetermined number of times, the process returns to step S1, to start over the Rankine start-up control from the beginning. Thus, in some cases, the Rankine start-up control may be executed repeatedly by the predetermined number of times.

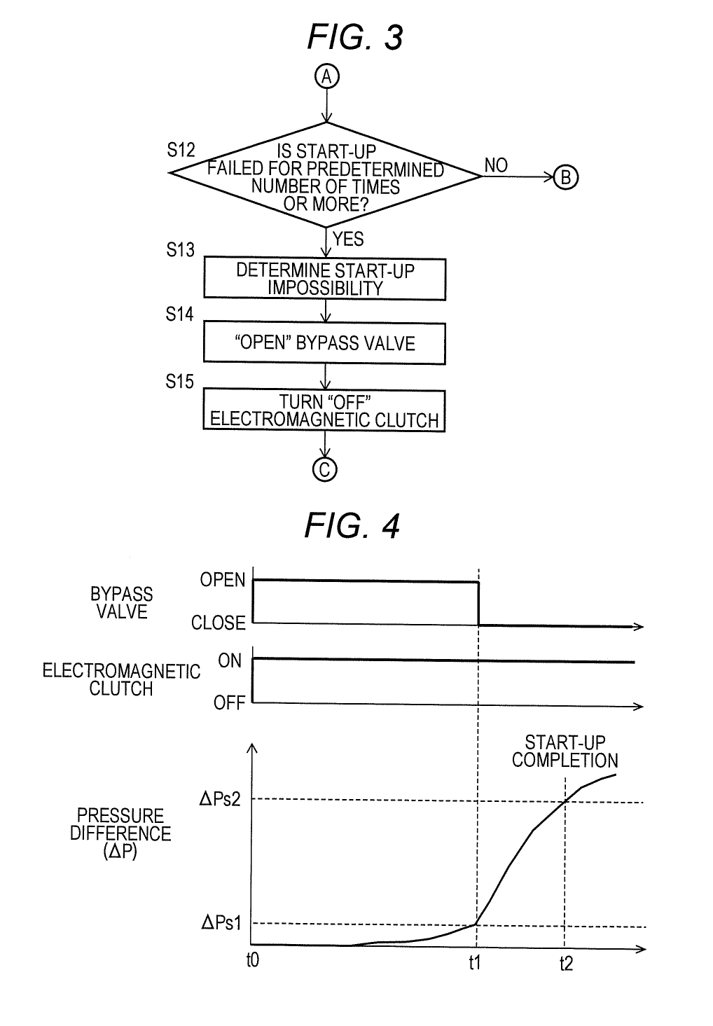

FIG. 4 is a timing diagram of the Rankine start-up control.

When starting up the Rankine cycle 2, the electromagnetic clutch 31 is turned on with the bypass valve 27 open (time t0). As described above, since the bypass valve 27 is open during stop of the Rankine cycle 2 in this embodiment, the electromagnetic clutch 31 is only normally turned on. However, when the bypass valve 27 is closed during stop of the Rankine cycle 2, the bypass valve 27 is opened and the electromagnetic clutch 31 is turned on. As a result, the pump 25 is activated, and the refrigerant circulates while bypassing the expander 23. Then, the degree of supercooling of the refrigerant on the outlet side of the condenser 24 increases, the flow rate of the liquid refrigerant supplied to the Rankine cycle 2 on the high-pressure side thereof increases, and the pressure difference ΔP between the high-pressure side pressure PH and the low-pressure side pressure PL also increases along with this.

Moreover, when the pressure difference ΔP increases to the first predetermined value ΔPs1, it is determined that a state in which the condensation performance in the condenser 24 is sufficiently high has been obtained and the refrigerant (liquid refrigerant), approximately 100% of which is liquefied, is continuously supplied to the pump 25 on the inlet side thereof. Then, the bypass valve 27 is closed (time t1). Thus, the refrigerant circulates via the expander 23.

When the bypass valve 27 is closed, the pressure difference ΔP increases at an even faster rate, and when the pressure difference ΔP increases to the second predetermined value ΔPs2, it is determined that the expander 23 is in a state capable of generating the driving force, that is, it is determined that the stat-up of the Rankine cycle 2 is completed, and then the Rankine start-up control is terminated (time t2).

Meanwhile, when the pressure difference ΔP does not reach the second predetermined value ΔPs2 even if the second predetermined time has elapsed after closing the bypass valve 27, the Rankine start-up control is started over from the beginning to try the start-up of the Rankine cycle 2 again. Moreover, when it does not lead to the start-up completion even if the Rankine start-up control is continuously executed for a predetermined number of times, the “start-up impossibility” is determined, and the bypass valve 27 is opened and the electromagnetic clutch 31 is turned off, to terminate the Rankine start-up control. In this case, it may be notified that there is abnormality in the Rankine cycle 2.

According to the above-described embodiment, when starting up the Rankine cycle 2, since the refrigerant is circulated while bypassing the expander 23 by actuating the pump 25 with the bypass valve 27 open, even when the gaseous refrigerant is mixed into the refrigerant on the inlet side of the pump 25, it is possible to promptly solve this problem. Moreover, by closing the bypass valve 27 when the pressure difference ΔP between the high-pressure side pressure PH and the low-pressure side pressure PL of the Rankine cycle 2 becomes the first predetermined value ΔPs1, it is possible to circulate the refrigerant via the expander 23 immediately after the refrigerant on the inlet side of the pump 25 becomes substantially 100% of liquid refrigerant.

As a result, it is possible to improve the start-up performance (rapidity and reliability of start-up) of the Rankine cycle 2, while efficiently operating the Rankine cycle 2 by reducing as much as possible the operation time in which the output of the Rankine cycle 2 is negative, that is, the time in which the pump 25 (and the expander 23) is driven by the engine 50.

Furthermore, since the high-pressure side pressure and the low-pressure side pressure of the Rankine cycle are also detected in the conventional Rankine cycle, there is no need to add a new sensor or the like to determine the pressure difference ΔP, and since the pressure difference ΔP is a value with less hunting, the stable control can be achieved.

Furthermore, when the first predetermined value ΔPs1 is set based on the temperature Ta of ambient air and/or the vehicle speed, it is possible to execute the Rankine start-up control, while reducing the influence of these variations on the start-up performance of the Rankine cycle 2. As a result, more stable control can be achieved.

The preferred embodiment of the invention has been described above, but it should be apparent that the invention is not intended to be limited to such embodiment, and modifications and variations can be made based on the technical ideas of the invention. Some modified examples will be described below.

### Modified Example 1

In the above-described embodiment, the pressure difference ΔP between the high-pressure side pressure PH and the low-pressure side pressure PL of the Rankine cycle 2 is used as a parameter indicating the condensation capacity of the condenser 24. However, the invention is not limited to this, and in addition to or instead of the pressure difference ΔP, the degree of supercooling (subcooling) of the refrigerant on the outlet side of the condenser 24 (the inlet side of pump 25) may be used. In this case, a temperature sensor and a pressure sensor are installed between (the outlet of) the condenser 24 and (the inlet of) the pump 25, and the control unit 4 calculates (determines) the degree of supercooling of the refrigerant, based on the temperature measured by the temperature sensor and the pressure measured by the pressure sensor 52.

Moreover, when starting up the Rankine cycle, the control unit 4 executes the control to actuate the pump 25 with the bypass valve 27 open, and to close the bypass valve 27 when the degree of supercooling of the refrigerant on the outlet side of the condenser 24 becomes a predetermined value or more. The predetermined value in this case may be, for example, a value (refrigerant temperature) in which the refrigerant on the outlet side of the condenser 24 can be sufficiently liquefied. Also in this case, it is possible to obtain the same effects as that of the above-described embodiment.

### Modified Example 2

The flow rate of the liquid refrigerant sent from the pump 25 may be used as a parameter indicating the condensation capacity of the condenser 24. The reason is that, as the condensation capacity of the condenser 24 increases, the flow rate of the liquid refrigerant sent from the pump 25 also increases. In this case, a flow sensor that measures the flow rate of liquid refrigerant is provided on the outlet side of the pump 25.

Moreover, when starting up the Rankine cycle, the control unit 4 executes the control to actuate the pump 25 with the bypass valve 27 open, and to close the bypass valve 27 when the flow rate of the liquid refrigerant sent from the pump 25 becomes a predetermined value or more. The predetermined value in this case may be set, for example, to the flow rate sent from the pump 25 when the refrigerant on the inlet side of the pump 25 is sufficiently liquefied. Also in this case, it is possible to obtain the same effects as that of the above-described embodiment.

Furthermore, since there is a correlation between the refrigerant flow rate and the pressure loss of the condenser 24, a pressure difference between the inlet side and the outlet side of the condenser 24 may be used as a parameter indicating the condensation capacity of the condenser 24. In this case, for example, a pressure sensor is provided on each of the inlet side and the outlet side of the condenser 24, and the control unit 4 calculates (determines) the pressure difference between the inlet side and the outlet side of the condenser 24.

### Modified Example 3

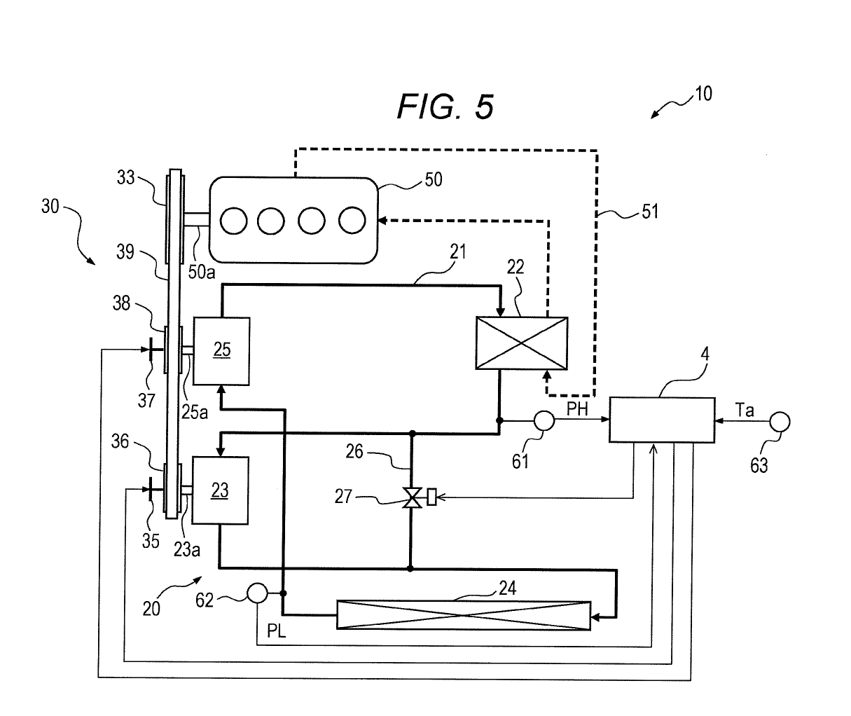

In the above-described embodiment, the expander 23 and the pump 25 are formed as the “pump-integrated expander 28” connected by the same rotating shaft 28a, but as illustrated in FIG. 5, the expander 23 and the pump 25 may be separately formed. In this case, the exhaust heat recovery device 10 includes: a Rankine cycle 20 in which the expander 23 and the pump 25 are separately formed; a transmission mechanism 30; and the control unit 4.

The transmission mechanism 30 has a crank pulley 33 attached to the crankshaft 50a of the engine 50, an expander pulley 36 attached to an output shaft 23a of the expander 23 via a first electromagnetic clutch 35, a pump pulley 38 attached to the drive shaft 25a of the pump 25 via a second electromagnetic clutch 37, and a belt 39 that is wrapped around the crank pulley 32, the expander pulley 36, and the pump pulley 38.

Moreover, when starting up the Rankine cycle 20, the control unit 4 executes the control to actuate the pump 25 by turning on the second electromagnetic clutch 37 with the bypass valve 27 open, and then to turn on the first electromagnetic clutch 35 and to close the bypass valve 27, when the parameter indicating the condensation capacity of the condenser 24 becomes a predetermined value or more. Also in this case, it is possible to obtain the same effects as that of the above-described embodiment. The pump 25 may be configured as an electric pump, and the control unit 4 may be configured to output a drive signal to the pump 25.

### Other Modified Examples

The exhaust heat recovery device according to the above-described embodiment is configured to assist the engine output by the driving force of the expander 23, but the present invention is also applicable to a power regeneration type exhaust heat recovery device that rotates a generator by the driving force of the expander 23. In this case, for example, the expander, the pump, and the generator motor can be integrated by being connected with the same rotating shaft.

Furthermore, the exhaust heat recovery device according to the above-described embodiment is mounted on a vehicle, and recovers and uses exhaust heat of an engine of the vehicle, but the present invention is also applicable to an exhaust heat recovery device that recovers and uses exhaust heat from an external heat source (for example, an exhaust heat recovery device that recovers and uses factory exhaust heat, and an exhaust heat recovery device that recovers and uses exhaust heat of an engine of a construction machine).

### REFERENCE SYMBOL LIST

1, 10 Exhaust heat recovery device
2, 20 Rankine cycle
3, 30 Transmission mechanism
31 Electromagnetic clutch
4 Control unit
21 Refrigerant circulating passage
22 Evaporator
23 Expander
24 Condenser
25 Pump
26 Bypass passage
27 Bypass valve
28 Pump-integrated expander
50 Engine
61, 62 Pressure sensor

1. An exhaust heat recovery device comprising:
a Rankine cycle in which a heater configured to heat and vaporize refrigerant by exhaust heat of an external heat source, an expander configured to generate power by expanding the refrigerant passed through the heater, a condenser configured to condense the refrigerant passed through the expander, and a pump configured to send the refrigerant passed through the condenser to the heater are disposed in a circulation passage of the refrigerant;
a bypass flow passage that allows the refrigerant to circulate while bypassing the expander;
a bypass valve that opens and closes the bypass flow passage; and
a control unit that, when starting up the Rankine cycle, executes control to actuate the pump with the bypass valve open, and then to close the bypass valve when a parameter indicating condensation capacity of the condenser becomes a predetermined value or more.

2. The exhaust heat recovery device according to claim 1, further comprising:
a pressure difference determining unit that determines a pressure difference between a high-pressure side and a low-pressure side of the Rankine cycle,
wherein when starting up the Rankine cycle, the control unit executes control to actuate the pump with the bypass valve open, and then to close the bypass valve when the pressure difference between the high-pressure side and the low-pressure side of the Rankine cycle becomes a predetermined value or more.

3. The exhaust heat recovery device according to claim 2, further comprising:
a temperature measuring unit that measures a temperature of ambient air,
wherein the control unit sets the predetermined value to a greater value as the temperature of the ambient air measured by the temperature measuring unit decreases.

4. The exhaust heat recovery device according to claim 1,
wherein the expander and the pump in the Rankine cycle are integrally connected to each other.
